(19) United States
(12) Patent Application Publication
(10) Pub. No.: US 2021/0240351 A1
(43) Pub. Date: Aug. 5, 2021

(54) REMOTE COPY SYSTEM AND REMOTE COPY MANAGEMENT METHOD

(71) Applicant: HITACHI, LTD., Tokyo (JP)

(72) Inventors: Nobuhiro YOKOI, Tokyo (JP); Tomohiro KAWAGUCHI, Tokyo (JP); Akira DEGUCHI, Tokyo (JP)

(73) Assignee: HITACHI, LTD., Tokyo (JP)

(21) Appl. No.: 17/014,296

(22) Filed: Sep. 8, 2020

(30) Foreign Application Priority Data
Feb. 4, 2020 (JP) 2020-017130

(51) Int. Cl. G06F 3/06

(52) U.S. Cl. CPC G06F 3/065; G06F 3/0683; G06F 3/067; G06F 3/0619

(57) ABSTRACT

A first storage system that provides a primary site and a second storage system that provides a secondary site are provided to quickly and easily switch between the storage systems. A storage controller of the storage system performs remote copy from a first data volume of the first storage system to a second data volume of the second storage system, after a failover is performed from the primary site to the secondary site, accumulates data and operation that are processed at the secondary site in a journal volume of the second storage system as a secondary site journal, and restores the first data volume using the secondary site journal when the primary site is recovered.

### BACKGROUND OF THE INVENTION

### 1. Field of the Invention

The present disclosure relates to a remote copy system and a remote copy management method.

### 2. Description of the Related Art

In recent years, there is an increasing demand for automation of disaster recovery (DR). In the DR, a remote copy function for multiplexing and holding data among a plurality of storage systems disposed at a plurality of sites and operation of a storage system using the function are known in preparation for data lost when a disaster such as an earthquake or a fire occurs.

Specifically, while one of the storage systems is operated as a primary site to execute data processing or the like, another storage system is used as a secondary site to perform remote copy of a data volume. When a disaster occurs at the primary site, a failover (F.O.) for switching a business of the primary site to the secondary site is performed. The remote copy includes a synchronous remote copy and an asynchronous remote copy. In the synchronous remote copy, after data is processed at the primary site, processing of the same content is performed at the secondary site, and then a completion response is performed. In the asynchronous remote copy, a completion response is performed by processing data at the primary site, and thereafter, processing of the same content is performed at the secondary site. For example, in a case where the synchronous remote copy is adopted when the storage system of the secondary site is located at a remote location, a delay to the completion response increases according to a distance. In such a case, the asynchronous remote copy is effective.

US Patent Application Publication 2005/0033827 specification (Patent Literature 1) discloses a technique of performing an asynchronous remote copy using a journal which is information indicating a history related to update of source data.

According to Patent Literature 1, upon receipt of a write command, a copy source storage system at a primary site writes data to a data write volume and journal data to a journal volume, and returns a response to a server system. A copy destination storage system of a remote site reads the journal data from the journal volume of the copy source storage system asynchronously with the write command, and stores the journal data in its own journal volume. Then, the copy destination storage system restores the data copied to a copy destination data write volume based on the stored journal data.

Thereafter, if a failure occurs in the copy source storage system, an I/O to the copy source storage system is stopped, and after reproducing the same operating environment as the copy source storage system on the copy destination storage system, the I/O can be resumed and the business can be continued.

However, in a related technique, there is a case in which time and effort are required for switching between storage systems. For example, the storage system may process an operation of a snapshot that generates a replica of the data volume at a time point of a request. Unlike processing of data, such as a write request, the snapshot does not add changes to contents of the data volume at that time point. However, the snapshot may be used to change the contents of the data volume, such as restoring data back to a state of the snapshot generated in the past. Therefore, even if the write command is transferred to the copy destination via the journal, it is not always possible to reflect all changes in the data. It is also desirable to reflect an operation of operating an environment of the volume, such as changing a size of the volume, to the copy destination. If an operation reflecting a change other than the write is performed manually, an enormous amount of time and labor are required.

In particular, when a failback to the primary site is required as soon as possible after a failover to the secondary site, for example, performances of the primary site and the secondary site are different, it is desirable to quickly switch from a storage system of the secondary site to a storage system of the primary site. However, if restoration from the snapshot is performed at the secondary site, a large amount of data is copied after the recovery of the primary site, and time is required.

From these facts, an important problem is how to quickly and easily switch between the storage systems and shorten the time required for recovering a business environment.

### SUMMARY OF THE INVENTION

The disclosure has been made in view of the above problems, and an object thereof is to provide a remote copy system and a remote copy management method that are capable of quickly and easily switching between storage systems.

In order to achieve the above object, one of a typical remote copy system and remote copy management method according to the disclosure includes: a first storage system that provides a primary site; and a second storage system that provides a secondary site, in which a storage controller of the storage system performs remote copy from a first data volume of the first storage system to a second data volume of the second storage system, after a failover is performed from the primary site to the secondary site, accumulates data and operation that are processed at the secondary site in a journal volume of the second storage system as a secondary site journal, and restores the first data volume using the secondary site journal when the primary site is recovered.

According to the disclosure, it is possible to quickly and easily switch between storage systems. Problems, configurations, and effects other than those described above will become apparent from the following description of the embodiment.

### BRIEF DESCRIPTION OF THE DRAWINGS

FIG. 1 is a configuration diagram showing a remote copy system according to an embodiment of the disclosure.

FIG. 2 is a diagram showing a virtual storage system.

FIG. 3 is a diagram showing a program and information that are used by the remote copy system.

FIG. 4 is a diagram showing configurations of tables and information (part 1).

FIG. 5 is a diagram showing configurations of tables and information (part 2).

FIGS. 6A and 6B are diagrams showing operations related to a failover (part 1).

FIGS. 7A and 7B are diagrams showing operations related to the failover (part 2).

FIG. 8 is a diagram showing an entire journal processing.

FIG. 9 is a flowchart showing a processing procedure of each program (part 1).

FIG. 10 is a flowchart showing a processing procedure of each program (part 2).

FIG. 11 is a flowchart showing a processing procedure of each program (part 3).

FIG. 12 is a flowchart showing a processing procedure of each program (part 4).

FIG. 13 is a flowchart showing a processing procedure of each program (part 5).

FIG. 14 is a flowchart showing a processing procedure of each program (part 6).

FIG. 15 is a flowchart showing a processing procedure of each program (part 7).

FIG. 16 is a flowchart showing a processing procedure of each program (part 8).

FIG. 17 is a flowchart showing a processing procedure of each program (part 9).

FIG. 18 is a flowchart showing a processing procedure of each program (part 10).

FIG. 19 is a flowchart showing a processing procedure of each program (part 11).

FIG. 20 is a flowchart showing a processing procedure of each program (part 12).

FIG. 21 is a flowchart showing a processing procedure of each program (part 13).

### DESCRIPTION OF THE PREFERRED EMBODIMENTS

Hereinafter, an embodiment of the disclosure will be described with reference to the drawings. The embodiment described below do not limit the invention according to the claims, and all of the elements and combinations thereof that are described in the embodiments are not necessarily essential to the solution of the invention.

In the following description, information that output can be obtained for input may be described by a representation such as an “xxx table”, but this information may be data of any structure. Therefore, the “xxx table” can be referred to as “xxx information”.

In the following description, the configuration of each table is an example, and one table may be divided into two or more tables, or all or a part of two or more tables may be one table.

In the following description, there are cases where processing is described with a “program” as a subject, but the program is executed by a processor unit to perform determined processing while appropriately using a storage unit and/or an interface unit or the like, so that the subject of processing may be a processor unit (or a device such as a controller including the processor unit).

The program may be installed in a device such as a computer, and may be, for example, in a program distribution server or a computer readable (for example, non-transitory) recording medium. Two or more programs may be implemented as one program, or one program may be implemented as two or more programs in the following description.

The “processor unit” is one or a plurality of processors. The processor is typically a microprocessor such as a central processing unit (CPU), and may be another type of processor such as a graphics processing unit (GPU). The processor may be a single core or a multi-core processor. The processor may be a processor in a broad sense such as a hardware circuit (for example, a field-programmable gate array (FPGA) or an application specific integrated circuit (ASIC)) that performs a part or all of the processing.

In the following description, an identification number is used as identification information of various targets, but identification information (for example, an identifier including letters and symbols) of a type other than the identification number may be adopted.

In the following description, in a case of describing the same kind of element without distinguishment, reference symbols (or common symbols among reference symbols) are used, and in a case of describing the same kind of elements distinguished from each other, an identification number (or reference symbol) of an element may be used.

### Embodiment

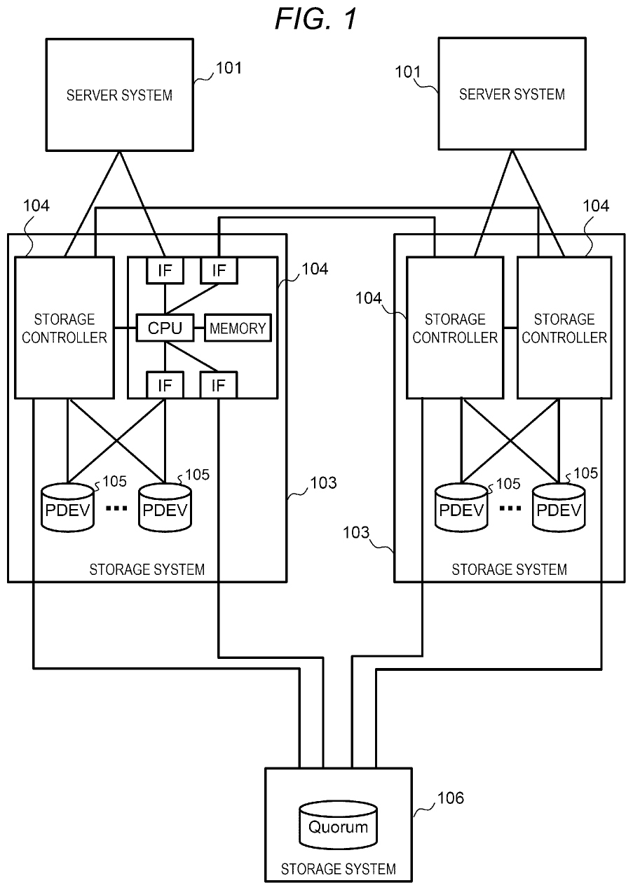

FIG. 1 is a configuration diagram showing a remote copy system according to an embodiment of the disclosure. The remote copy system shown in FIG. 1 includes two server systems 101, two storage systems 103, and one storage system 106.

The storage system 103 includes two storage controllers 104 having a redundant configuration, and one or a plurality of PDEVs 105. The PDEV 105 refers to a physical storage device, and is typically a nonvolatile storage device, such as a hard disk drive (HDD) or a solid state drive (SSD). Alternatively, a flash package or the like may be used.

Each storage controller 104 is connected to each of the PDEVs 105 in the same storage system and is connected to the other storage controller 104 in the same storage system.

The server system 101 can communicate with two storage controllers 104 of one storage system 103. Further, the storage controller 104 can communicate with the storage controller 104 of another storage system 103. The storage system 106 communicates with each of the storage controllers 104 and monitors an operating state of the storage system 103 using Quorum.

The storage controller 104 includes a CPU, a memory, and a plurality of interface units (IFs). The IF is used for connection with the PDEV 105, communication with the server system 101, communication with another storage system 103, and communication with the storage system 106.

Although four storage controllers 104 are shown in FIG. 1, the four storage controllers 104 cooperate to operate as a storage controller in the claims. Although FIG. 1 shows that two storage systems 103 and two storage controllers 104 per storage system 103 are provided, two or more storage systems 103 may be connected to each other, or the number of storage controllers 104 per storage system 103 may be two or more.

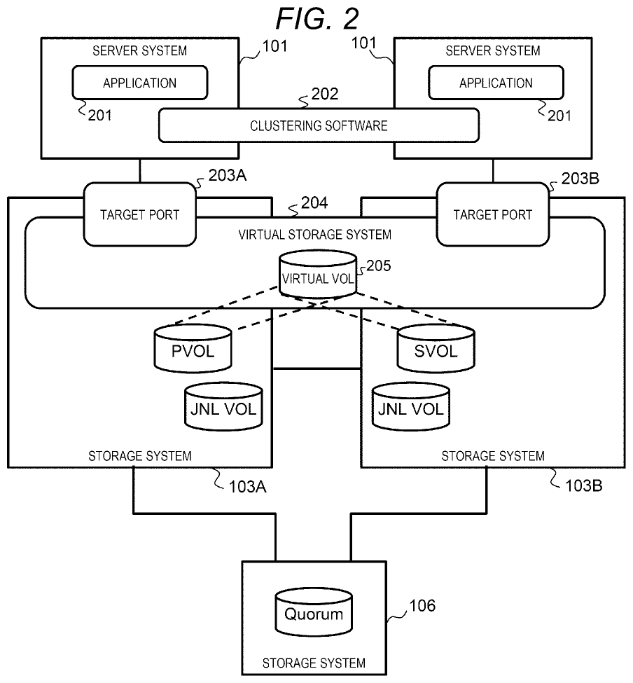

FIG. 2 is a diagram showing a virtual storage system. In FIG. 2, one of the storage systems 103 operates as a storage system 103A that provides a primary site. The other operates as a storage system 103B that provides a secondary site.

The storage system 103A uses the PDEV 105 as a data volume (PVOL) and a journal volume (JNL VOL). Similarly, the storage system 103B uses the PDEV 105 as a data volume (SVOL) and a journal volume (JNL VOL).

On the server system 101, an application 201 and clustering software 202 operate. The clustering software 202 causes the storage system 103A and the storage system 103B to cooperate with each other and provides a virtual storage system 204 to the application 201.

That is, when the application 201 accesses a virtual volume 205 of the virtual storage system 204, processing is performed by the PVOL via a target port 203 of the storage system 103A which is the primary site. The processing at the primary site is accumulated in the journal volume of the storage system 103A as a primary site journal.

The storage system 103B, which is the secondary site, appropriately reads the primary site journal and reflects the primary site journal in the SVOL, thereby performing remote copy from the storage system 103A to the storage system 103B.

Then, if the storage system 106 detects an abnormality of the primary site, failover is performed from the storage system 103A to the storage system 103B, and thereafter the storage system 103B processes an access from the application 201.

Such switching of the storage system is not recognized by the application 201 that uses the virtual storage system via the clustering software 202.

Thereafter, if the storage system 103A is recovered, a reverse resync that reflects the processing at the secondary site to the PVOL is performed, and failback is performed from the storage system 103B to the storage system 103A.

Here, in the remote copy system according to the present embodiment, not only data write processing, but also operation processing of operating environments of snapshots and volumes is accumulated in the primary site journal and reflected in the SVOL of the secondary site. Further, the data processing and the operation processing executed at the secondary site after the failover is accumulated as a secondary site journal, and the reverse resync of PVOL is performed using the secondary site journal, so that switching between the storage systems is performed quickly and easily.

The primary site journal stores the data processing and the operation processing together with time point information. The storage system 103B acquires the primary site journal at a predetermined timing, and executes processing indicated in the primary site journal in order, thereby implementing the remote copy by matching the SVOL with the PVOL.

That is, if data synchronization processing (for example, a snapshot) requiring data synchronization is included in the primary site journal, the data synchronization processing is executed by the SVOL in the remote copy. Therefore, it is possible to restore the SVOL based on the data synchronization processing at a time of the failover.

The secondary site journal stores the data processing and the operation processing together with the time point information. When the storage system 103A restores the PVOL by the reverse resync, the storage system 103A acquires the secondary site journal, and executes processing indicated in the secondary site journal in order, thereby matching the PVOL with the SVOL.

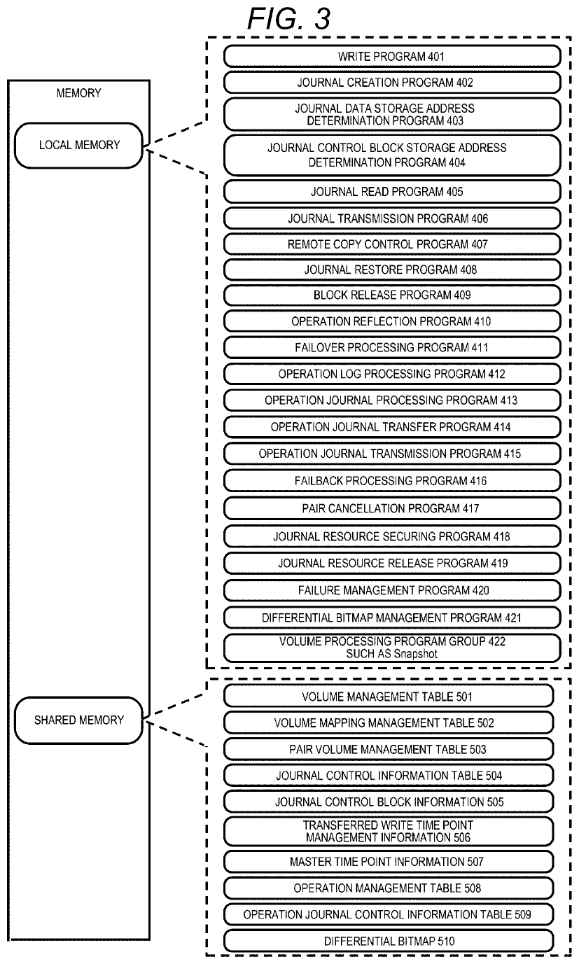

Next, a program and information used by the remote copy system will be described. FIG. 3 is a diagram showing the program and information that are used by the remote copy system. The storage controller 104 expands and uses various programs and various types of information in the memory. A local memory is a region of the memory used for the expansion of the program. A shared memory is a region of the memory used for the expansion of information.

Specifically, a write program 401, a journal creation program 402, a journal data storage address determination program 403, and a journal control block storage address determination program 404, a journal read program 405, a journal transmission program 406, a remote copy control program 407, a journal restore program 408, a block release program 409, and an operation reflection program 410, a failover processing program 411, an operation log processing program 412, an operation journal processing program 413, an operation journal transfer program 414, an operation journal transmission program 415, a failback processing program 416, a pair cancellation program 417, a journal resource securing program 418, a journal resource release program 419, a failure management program 420, a differential bitmap management program 421, and a volume processing program group 422 such as a Snapshot are expanded in the local memory.

Similarly, a volume management table 501, a volume mapping management table 502, a pair volume management table 503, a journal control information table 504, journal control block information 505, transferred write time point management information 506, master time point information 507, an operation management table 508, an operation journal control information table 509, and a differential bitmap 510 are expanded in the shared memory.

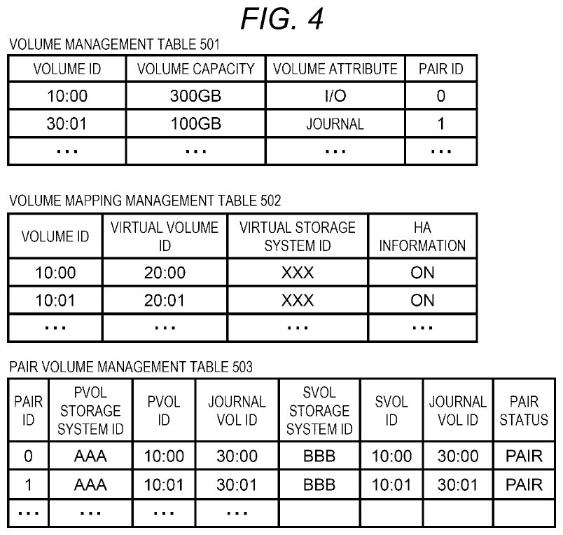

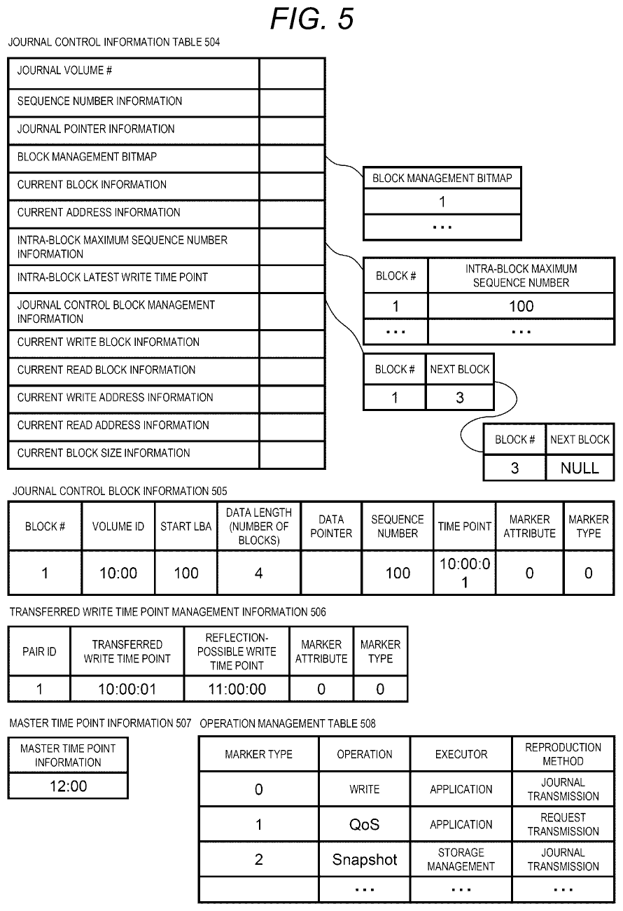

FIGS. 4 and 5 are diagrams showing configurations of tables and information. As shown in FIGS. 4 to 5, the volume management table 501 includes items such as a volume ID, a volume capacity, a volume attribute, and a pair ID. Here, if the volume attribute is “I/O”, the volume attribute is a data volume that is a target of read and write (input/output) of data from the server system 101. If the volume attribute is “journal”, the volume attribute is a journal volume indicating a history of processing for the data volume.

The volume mapping management table 502 includes items such as a volume ID, a virtual volume ID, a virtual storage system ID, and an HA information. The pair volume management table 503 includes items such as a pair ID, a PVOL storage system ID, a PVOL ID, a journal VOL ID, an SVOL storage system ID, an SVOL ID, a journal VOL ID, and a pair status.

The journal control information table 504 includes items such as a journal volume number, sequence number information, a journal pointer, a block management bitmap, current block information, current address information, intra-block maximum sequence number information, an intra-block latest write time point, journal control block management information, current write block information, current read block information, current write address information, current read address information, and current block size information.

The journal control block information 505 includes items such as a block number, a volume ID, a start LBA, a data length (the number of blocks), a data pointer, a sequence number, a time point, a marker attribute, and a marker type.

The transferred write time point management information 506 includes items such as a pair ID, a transferred write time point, a reflection-possible write time point, a marker attribute, and a marker type. The master time point information 507 manages the time point information.

The operation management table 508 associates an operation, an executor, and a reproduction method with respect to the marker type. For example, for the marker type “0”, the operation is “write”, the executor is “application”, and the reproduction method is “journal transmission”. For the marker type “1”, the operation is “QoS”, the executor is “application”, and the reproduction method is “request transmission”. For the marker type “2”, the operation is “Snapshot”, the executor is “storage management”, and the reproduction method is “journal transmission”. The storage management means that the storage system 103 is the executor, regardless of a request from the application.

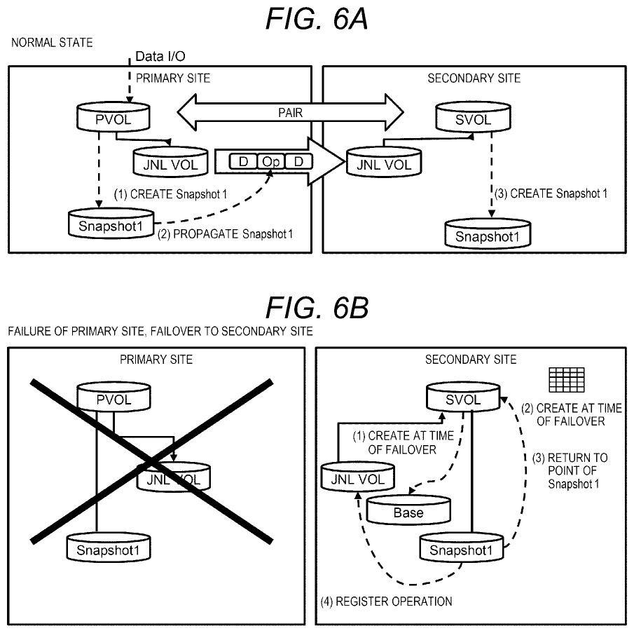

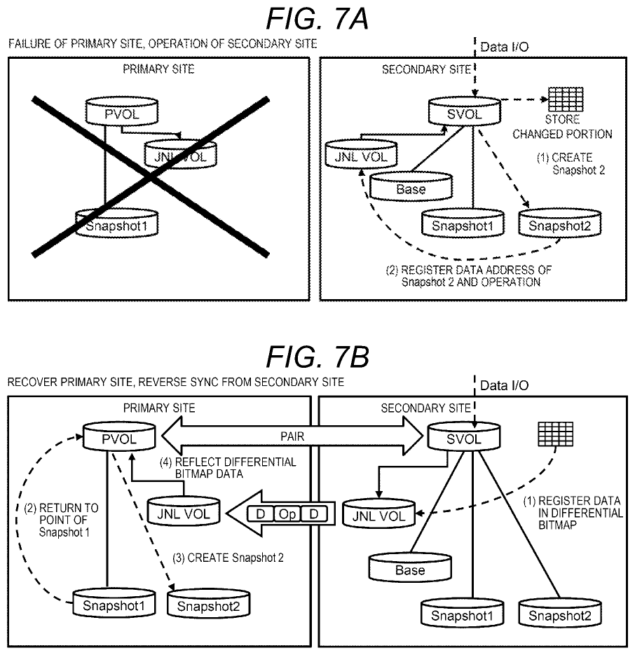

Next, the operation related to the failover will be described. FIGS. 6A to 7B are diagrams showing operations related to the failover. FIG. 6A shows an operation in a normal state. In FIG. 6A, a first snapshot (Snapshot 1) is created at the primary site (1). The snapshot creation operation is stored in the journal volume (JNL VOL) as a primary site journal, similar to the data write (I/O). Therefore, by sending the primary site journal to the secondary site in which the pair is established, the Snapshot 1 is propagated to the secondary site (2). In the secondary site, the Snapshot 1 is created by reading and executing the primary site journal.

FIG. 6B shows an example in which when a failover occurs due to a failure of the primary site, a quiesce point is designated by the Snapshot 1. If the quiesce point of the Snapshot is designated and returned to, there is an advantage that it may not be considered up to what time point the primary site journal is properly sent at a time of reverse sync. The differential bitmap takes a change difference from a time point of returning at the Snapshot. If there are two Snapshot points, and first, a Snapshot 2 is returned to, and then the Snapshot 1 is further returned to, the change difference after returning to the Snapshot 1 is taken as the differential bitmap.

In the Snapshot 1, the SVOL reflecting the primary site journal may be used as it is without designating the quiesce point. When the Snapshot is used to be returned to, a Snapshot indicating a state before the return may be created and returned to, or a specification for forgetting to change up to the returned Snapshot point may be used. The SVOL reflecting an amount sent by the primary site journal at the time of the failover may be saved as Base. In this case, a Snapshot 0 as Base is created at the time of the failover (1), and a differential bitmap using the Snapshot 0 as a base point is created (2). Then, the SVOL is returned to the quiesce point of the Snapshot 1 by reflecting the Snapshot 1 (3), and an operation reflecting the Snapshot 1 is registered in the secondary site journal (4).

The Snapshot that is also at the primary site and the Snapshot that is newly created at the secondary site are distinguished and managed internally. This is because, in a case of the Snapshot newly created at the secondary site, it is necessary to register a data address and reflect the data address in the primary site.

FIG. 7A shows an operation of the secondary site during the failure of the primary site. As shown in FIG. 7A, the differential bitmap records a changed portion after switching to the secondary site (when the Snapshot is returned to, the changed portion from that point is recorded as the differential bitmap.)

If the Snapshot 2 is created (1), a data address of the created Snapshot 2 is registered in the secondary site journal together with the operation (2). After the creation of the Snapshot 2, a changed portion from the creation of the Snapshot 2 is recorded in a new differential bitmap corresponding to the Snapshot 2. This is because the changed portion until the Snapshot 2 is taken is held as a differential bitmap corresponding to the Snapshot 1.

When the primary site journal is reflected, and data is processed for a while and then returned to the Snapshot 1, the differential bitmap up to that time point may be duplicated and held together with the Base, and may be used to determine how much the Base from the PVOL on a primary side. Similarly, when returning to the Snapshot point, changed data up to that point and the differential bitmap may be held internally so that the return to the Snapshot can be canceled.

FIG. 7B shows an operation in which the primary site is recovered and the reverse sync is performed from the secondary site. There are two methods when the reverse sync is performed in FIG. 7B. One method is the operation of returning to the Snapshot 1 and JNL transfer of the changed data recorded in the differential bitmap (1). At this time, when the Snapshot 2 is taken, the data of the Snapshot 2 is sent, then the Snapshot 2 operation is sent, and then the data of the differential bitmap is sent. At the primary site, return to the Snapshot 1 is performed according to the secondary site journal (2), the Snapshot 2 is created (3), and the data of the differential bitmap is reflected (4) to perform restoration.

The other method is to postpone the reflection of the Snapshot and return the reflection of the Snapshot to a latest state at an early stage. In this case, the differential bitmap is sent first, and then the JNL sends differential data of the Snapshot and Snapshot management information (information for recognizing presence of the Snapshot). At this time, when the operation of returning from the Snapshot is performed after the failover as shown in FIG. 6B, the differential bitmap is reflected after the operation of remembering the point of the Snapshot and returning to the Snapshot first at the primary site.

For this reason, the operation of returning to the Snapshot, the data, and the differential bitmap are registered in JNL so as to be sent first. When the Snapshot is taken at the secondary site, only the differential bitmap is not enough, and data of the Snapshot 2 also needs to be sent first. Alternatively, a method may be used in which the differential bitmap from when returning to a snapshot place of the primary site is stored and is sent first.

In a case where there is no return to the point of the Snapshot 1 in FIG. 6B, when a difference between the PVOL and the Base is taken, how far being sent to the SVOL is judged, and an amount of being sent is taken into account to resume, an amount that is not sent at the primary site is returned, and the reverse sync is performed. When the primary site that is not sent is utilized, the data is reflected in the Snapshot taken at the secondary site (the data to be a base of the Snapshot is changed). Since pair synchronization is resumed, the I/O to the secondary site after the registration of the data of the differential bitmap is stored in the JNL. The primary site may be set to resume from a latest Snapshot point. At this time, transmission of the differential bitmap is not essential.

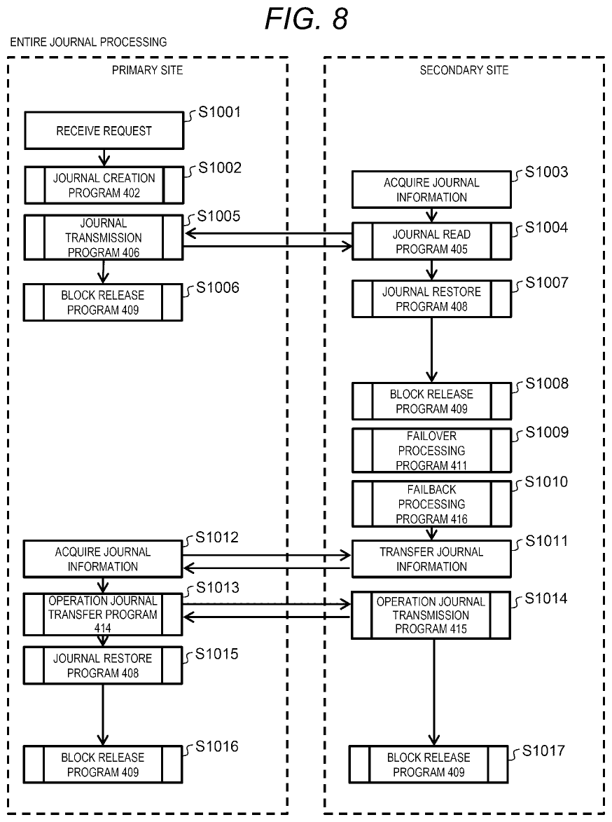

Next, various processing procedures will be described. FIG. 8 is a diagram showing entire journal processing. First, when a request for write or the like is received at the primary site (step S1001), the journal creation program 402 operates (step S1002). When journal information is acquired at the secondary site (step S1003), the journal read program 405 of the secondary site operates (step S1004), and the journal transmission program 406 of the primary site is operated (step S1005). The journal transmission program 406 of the primary site transmits the primary site journal to the secondary site, and operates the block release program 409 of the primary site (step S1006). Upon receiving the primary site journal, the journal read program 405 of the secondary site operates the journal restore program 408 (step S1007), and operates the block release program 409 of the secondary site (step S1008).

When an abnormality occurs at the primary site, the failover processing program 411 operates (step S1009), and the failover is performed. Thereafter, if the primary site is recovered, the failback processing program 416 operates (step S1010), and transfers the journal information of the secondary site to the primary site (step S1011). When the primary site acquires the journal information (step S1012), the operation journal transfer program 414 operates (step S1013), and the operation journal transmission program 415 of the secondary site is operated (step S1014).

The operation journal transmission program 415 of the secondary site transmits the secondary site journal to the primary site, and operates the block release program 409 of the secondary site (step S1017). Upon receiving the secondary site journal, the operation journal transfer program 414 of the primary site operates the journal restore program 408 (step S1015), and operates the block release program 409 of the primary site (step S1016). When the failback is performed at the primary site, the journal restore program executes restoration using a differential bitmap indicating processing at the secondary site.

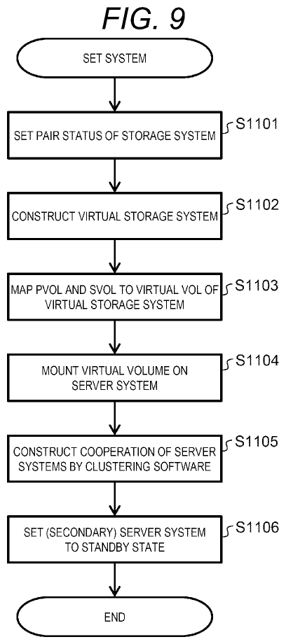

Next, a processing procedure of each program will be described with reference to FIGS. 9 to 21.

FIG. 9 is a flowchart showing a processing procedure related to a setting of the storage system 103. First, the storage controller 104 sets a pair status of the storage system 103 (step S1101). Thereafter, a virtual storage system is constructed (step S1102), and the PVOL and the SVOL are mapped to a virtual VOL of the virtual storage system (step S1103). Then, a virtual volume is mounted on the server system 101 (step S1104), and a cooperation of the server systems 101 performed by the clustering software 202 is constructed (step S1105). Then, one of the server systems 101 is set to a standby state as a secondary server system (step S1106). The secondary server system 101 is a standby system for when an abnormality occurs in the other (primary) server system 101.

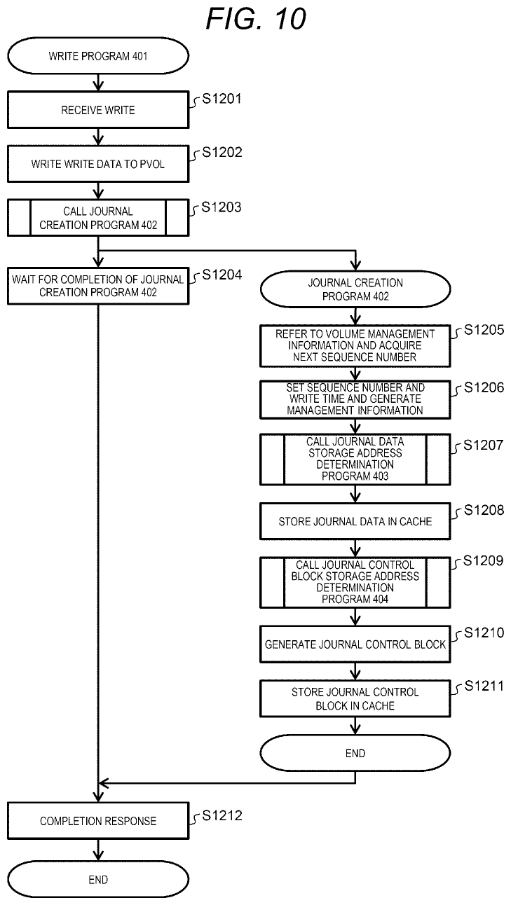

FIG. 10 is a flowchart showing a processing procedure of the write program 401. Upon receiving a write request from the application 201 (step S1201), the write program 401 writes write data to the PVOL (step S1202), calls the journal creation program 402 (step S1203), and waits for completion of the journal creation program (step S1204).

The journal creation program 402 refers to volume management information and acquires a next sequence number (step S1205). Then, the sequence number and write time are set, and management information is generated (step S1206). The journal creation program 402 calls the journal data storage address determination program 403 (step S1207), and stores journal data in a cache (step S1208). Thereafter, the journal creation program 402 calls the journal control block storage address determination program 404 (step S1209), generates a journal control block (step S1210), and stores the journal control block in the cache (step S1211), and the processing is ended. After the accommodation of the journal creation program 402, the write program 401 performs a completion response (step S1212), and the processing is ended.

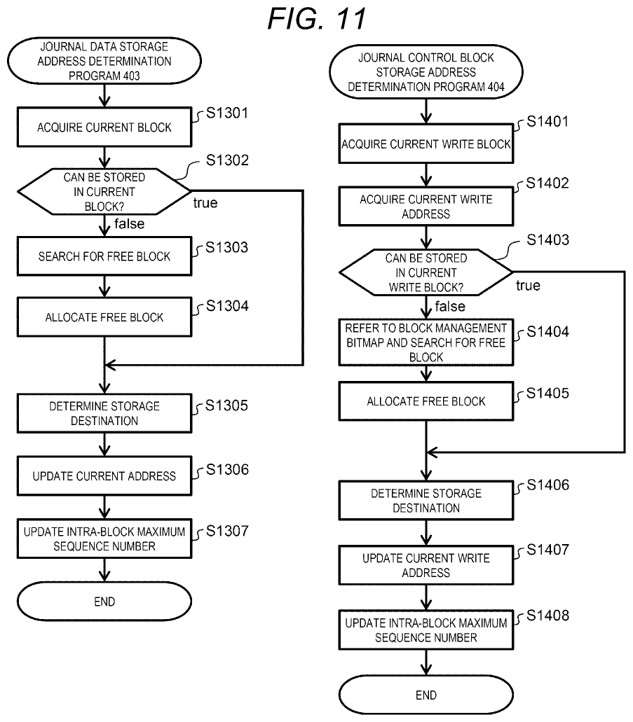

As shown in FIG. 11, the journal data storage address determination program 403 acquires a current block (step S1301), and determines whether the journal data can be stored in the current block (step S1302). If the journal data cannot be stored in the current block (step S1302; false), the journal data storage address determination program 403 searches for a free block (step S1303), and allocates the free block (step S1304).

After step S1304, or if the journal data can be stored in the current block (step S1302; true), the journal data storage address determination program 403 determines a storage destination (step S1305), updates a current address (step S1306), and updates an intra-block maximum sequence number (step S1307), and the processing is ended.

As shown in FIG. 11, the journal control block storage address determination program 404 acquires a current write block (step S1401), acquires a current write address (step S1402), and determines whether the journal control block can be stored in the current write block (step S1403). If the journal control block cannot be stored in the current write block (step S1403; false), the journal control block storage address determination program 404 refers to a block management bitmap, and searches for a free block (step S1404), and allocates the free block (step S1405).

After step S1405, or if the journal control block can be stored in the current write block (step S1403; true), the journal control block storage address determination program 404 determines a storage destination (step S1406), updates the current write address (step S1407), and updates the intra-block maximum sequence number (step S1408), and the processing is ended.

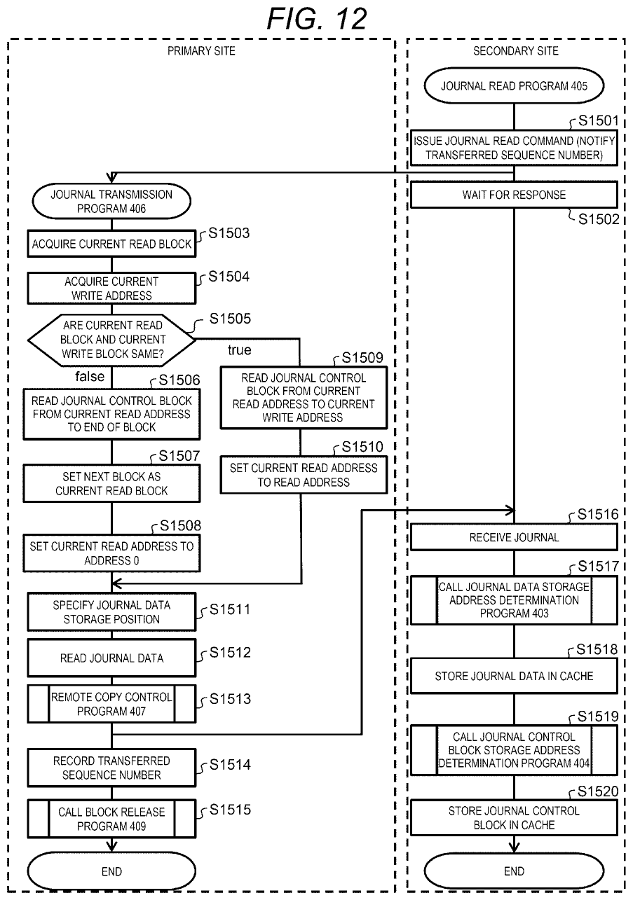

As shown in FIG. 12, the journal read program 405 of the secondary site issues a journal read command to notify a transferred sequence number (step S1501), and waits for a response from the primary site (step S1502). The journal transmission program 406 of the primary site acquires a current read block (step S1503), acquires the current write address (step S1504), and determines whether the current read block and the current write block are the same (step S1505).

If the current read block and the current write block are not the same (step S1505; false), the journal transmission program 406 reads the journal control block from a current read address to an end of the block (step S1506), sets a next block as the current read block (step S1507), and sets the current read address to an address 0 (step S1508).

On the other hand, if the current read block and the current write block are the same (step S1505; true), the journal control block from the current read address to the current write address is read (step S1509), and the current read address is set to a read address (step S1510).

After step S1508 or step S1510, the journal transmission program 406 specifies a journal data storage position (step S1511), and reads the journal data (step S1512). Thereafter, the remote copy control program 407 is operated (step S1513), the transferred sequence number is recorded (step S1514), the block release program 409 is called (step S1515), and the processing is ended.

When the journal transferred by the remote copy control program 407 is received (step S1516), the journal read program 405 of the secondary site calls the journal data storage address determination program 403 (step S1517), and stores the journal data in the cache (step S1518). Then, the journal control block storage address determination program 404 is called (step S1519), the journal control block is stored in the cache (step S1520), and the processing is ended.

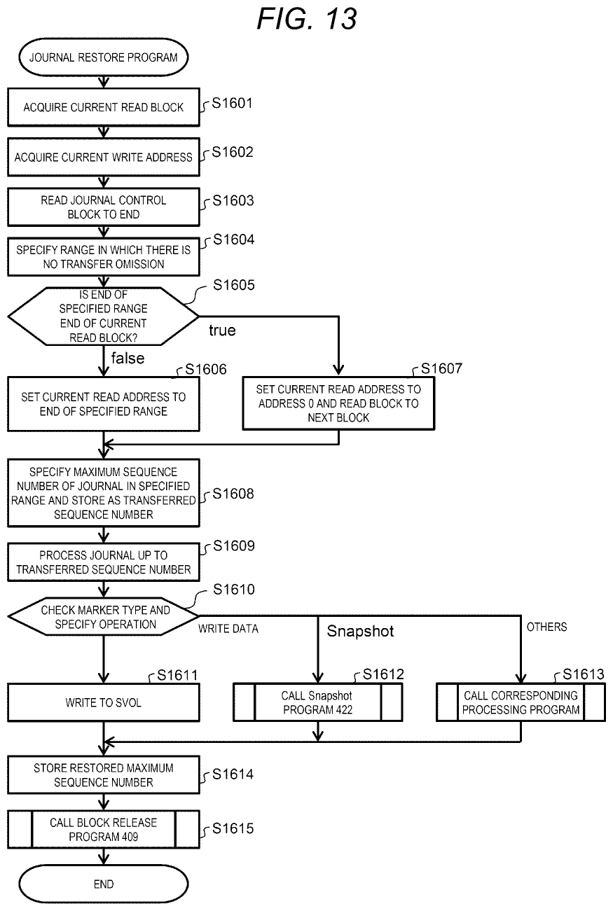

As shown in FIG. 13, when the journal restore program 408 acquires the current read block (step S1601) and acquires the current write address (step S1602), the journal control block is read to the end (step S1603), and a range in which there is no transfer omission is specified (step S1604). The journal restore program 408 determines whether an end of the specified range is an end of the current read block (step S1605).

If the end of the specified range is not the end of the current read block (step S1605; false), the journal restore program 408 sets the current read address to the end of the specified range (step S1606). If the end of the specified range is the end of the current read block (step S1605; true), the journal restore program 408 sets the current read address to the address 0 and the read block to the next block (step S1607).

After step S1606 or step S1607, the journal restore program 408 specifies a maximum sequence number of a journal in the specified range and stores the maximum sequence number as a transferred sequence (step S1608). The journal up to the transferred sequence number is processed (step S1609). The journal restore program 408 confirms a marker type of the processing and specifies an operation (step S1610). As a result, if the operation is write data, the write data is written to the SVOL (step S1611). If the operation is Snapshot, a Snapshot processing program 422 is called (step S1612). In other operations, a corresponding processing program is called (step S1613).

After steps S1611 to S1613, the journal restore program 408 stores a restored maximum sequence number (step S1614) and calls the block release program 409 (step S1615), and the processing is ended.

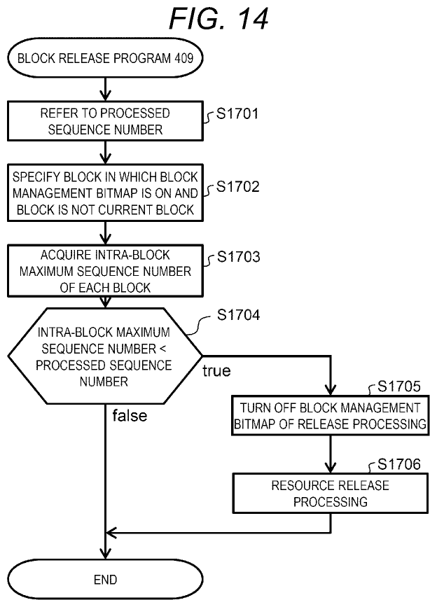

As shown in FIG. 14, the block release program 409 first refers to a processed sequence number (step S1701). Then, the block release program 409 specifies a block in which the block management bitmap is ON and the block is not a current block (step S1702), and acquires the intra-block maximum sequence number of each block (step S1703).

If the intra-block maximum sequence number is equal to or greater than the processed sequence number (step S1704; false), the block release program 409 ends the processing as it is. On the other hand, if the intra-block maximum sequence number is smaller than the processed sequence number (step S1704; true), the block management bitmap of release processing is turned OFF (step S1705), resource release processing is performed (step S1706), and the processing is ended.

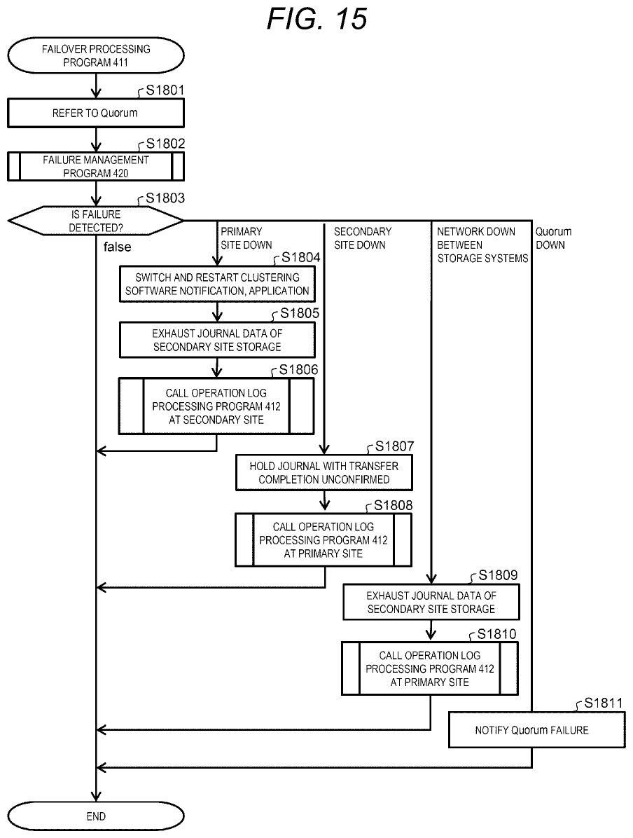

As shown in FIG. 15, the failover processing program 411 refers to Quorum (step S1801) and operates the failure management program 420 (step S1802). As a result, if a failure is not detected (step S1803; false), the processing is ended as it is.

On the other hand, if a failure of a primary site down is detected, the failover processing program 411 performs clustering software notification, application switching, and restart (step S1804). Then, the journal data of a secondary site storage is exhausted by executing all acquired primary site journals (step S1805), the operation log processing program 412 is called at the secondary site (step S1806), and the processing is ended.

If a failure of a secondary site down is detected, the failover processing program 411 holds the journal with transfer completion unconfirmed (step S1807) and calls the operation log processing program 412 at the primary site (step S1808), and the processing is ended.

If a failure of network down between the storage systems is detected, the failover processing program 411 exhausts the journal data of the secondary site storage by executing all the acquired primary site journals (step S1809) and calls the operation log processing program 412 at the primary site (step S1810), and the processing is ended. In a case of Quorum down, a Quorum failure notification is made (step S1811), and the processing is ended.

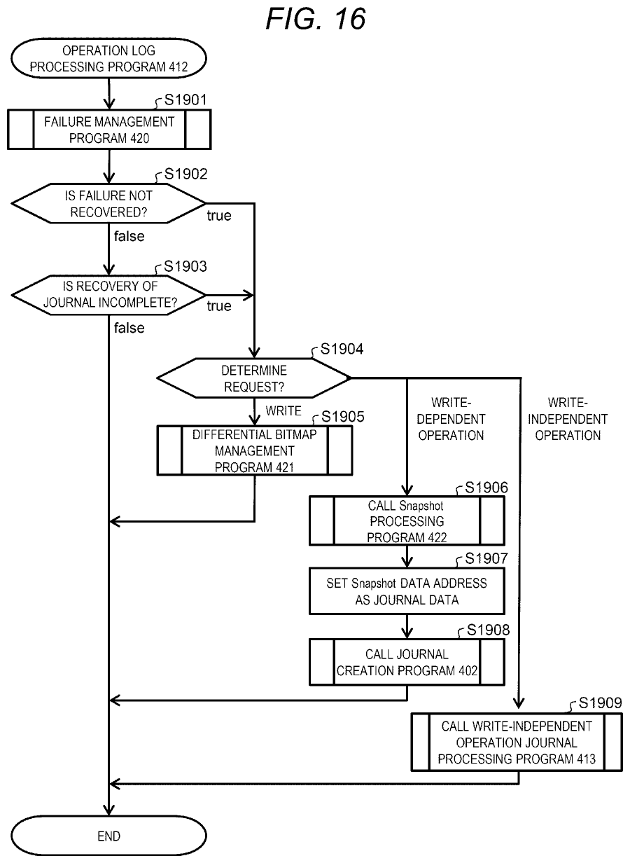

As shown in FIG. 16, the operation log processing program 412 operates the failure management program 420 (step S1901), and determines whether the failure is not recovered (step S1902). Then, if the failure is recovered (step S1902; false), the operation log processing program 412 further determines whether the recovery of the journal is incomplete (step S1903). As a result, if the recovery of the journal is completed (step S1903; false), the processing is ended as it is.

When the failure is not recovered (step S1902; true) or the journal recovery is incomplete (step S1903; true), the operation log processing program 412 determines a request (step S1904).

As a result of the determination, if the request is “write”, the operation log processing program 412 operates the differential bitmap management program 421 (step S1905), and the processing is ended.

As a result of the determination, if the request is “write-dependent operation”, the operation log processing program 412 calls the Snapshot processing program 422 (step S1906), and sets a Snapshot data address as the journal data (step S1907). Then, the journal creation program 402 is called (step S1908), and the processing is ended.

As a result of the determination, if the request is “write-independent operation”, the operation log processing program 412 calls the write-independent operation journal processing program 413 (step S1909), and the processing is ended.

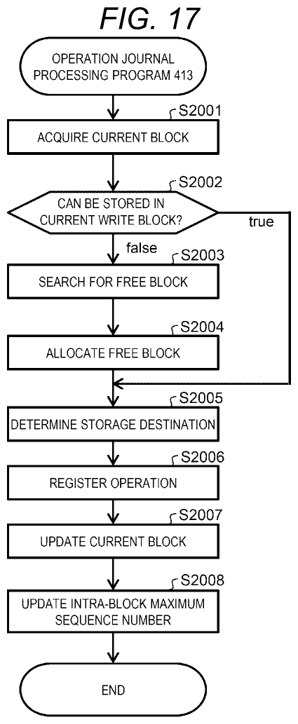

As shown in FIG. 17, the operation journal processing program 413 acquires the current block (step S2001), and determines whether the current block can be stored in the current write block (step S2002). If the current block cannot be stored in the current write block (step S2002; false), the operation journal processing program 413 searches for a free block (step S2003), and allocates the free block (step S2004).

After step S2004, or if the current block can be stored in the current write block (step S2002; true), the operation journal processing program 413 determines a storage destination (step S2005), registers the operation (step S2006), updates the current block (step S2007), and updates the intra-block maximum sequence number (step S2008), and the processing is ended.

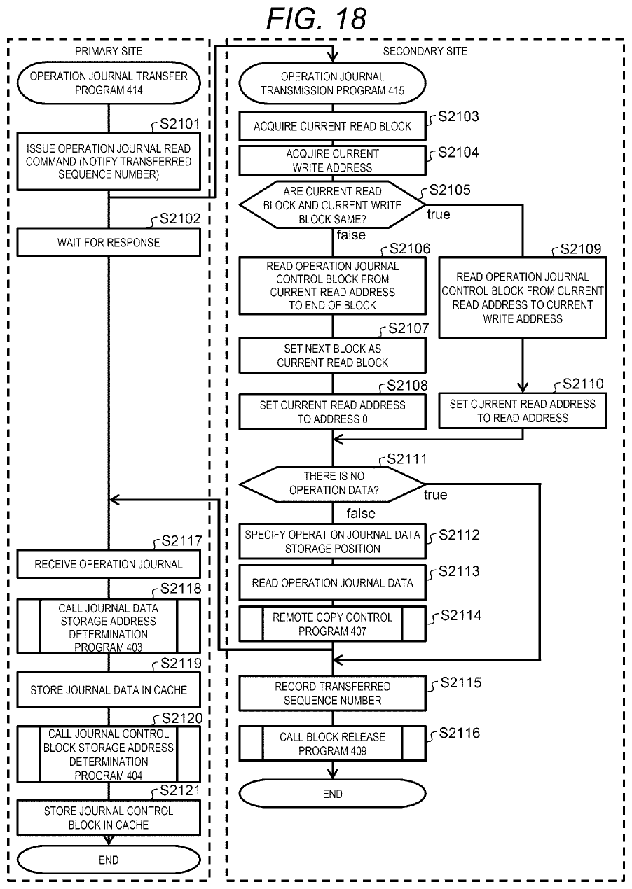

As shown in FIG. 18, the operation journal transfer program 414 of the primary site issues an operation journal read command to notify a transferred sequence number (step S2101), and waits for a response from the secondary site (step S2002). The operation journal transmission program 415 of the secondary site acquires a current read block (step S2103), acquires the current write address (step S2104), and determines whether the current read block and the current write block are the same (step S2105).

If the current read block and the current write block are not the same (step S2105; false), the operation journal transmission program 415 reads the journal control block from the current read address to the end of the block (step S2106), sets the next block as the current read block (step S2107), and sets the current read address to the address 0 (step S2108).

On the other hand, if the current read block and the current write block are the same (step S2105; true), the journal control block from the current read address to the current write address is read (step S2109), and the current read address is set to the read address (step S2110).

After step S2108 or step S2110, the operation journal transmission program 415 determines whether there is no operation data (step S2111). If there is operation data (step S2111; false), the operation journal transmission program 415 specifies an operation journal data storage position (step S2112), and reads the operation journal data (step S2113). Thereafter, the remote copy control program 407 is operated (step S2114). After step S2114 or when there is no operation data (step S2111; true), the operation journal transmission program 415 records the transferred sequence number (step S2115) and calls the block release program 409 (step S2116), and the processing is ended.

When the operation journal transferred by the remote copy control program 407 is received (step S2117), the operation journal transfer program 414 of the primary site calls the journal data storage address determination program 403 (step S2118), and stores the journal data in the cache (step S2119). Then, the journal control block storage address determination program 404 is called (step S2120), the journal control block is stored in the cache (step S2121), and the processing is ended.

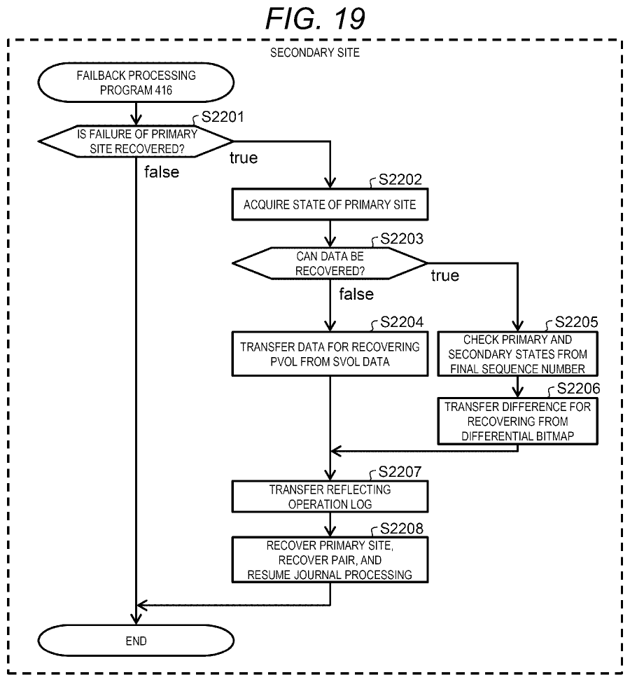

As shown in FIG. 19, the failback processing program 416 determines whether the failure of the primary site is recovered (step S2201). As a result of the determination, if the failure of the primary site is not recovered (step S2201; false), the processing is ended as it is.

If the failure of the primary site is recovered (step S2201; true), the failback processing program 416 acquires a state of the primary site (step S2202), and determines whether the data can be recovered (step S2203).

If the data cannot be recovered (step S2203; false), the failback processing program 416 transfers the data for recovering the PVOL from the SVOL (step S2204). If the data can be recovered (step S2203; true), the failback processing program 416 checks primary and secondary states from a final sequence number (step S2205), and transfers the difference for recovering from the differential bitmap (step S2206).

After step S2204 or step S2206, the failback processing program 416 performs transfer reflecting an operation log (step S2207), recovers the primary site, recovers the pair, and resumes the journal processing (step S2208), and the processing is ended.

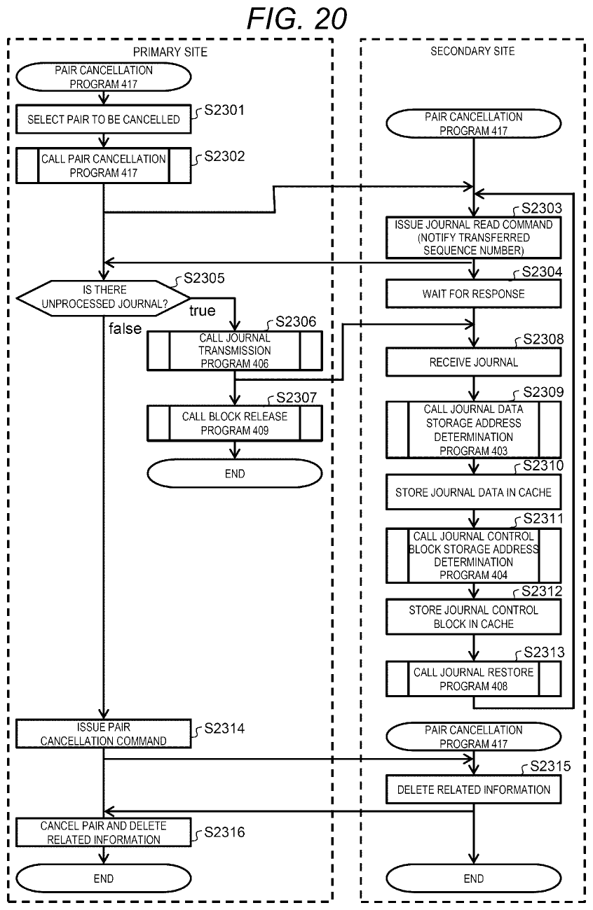

As shown in FIG. 20, the pair cancellation program 417 activated at the primary site selects a pair to be cancelled (step S2301), and calls the pair cancellation program 417 of the secondary site (step S2302).

The pair cancellation program 417 of the secondary site issues a journal read command to notify the transferred sequence number (step S2303), and waits for a response from the primary site (step S2304).

The pair cancellation program 417 of the primary site receives the journal read command from the pair cancellation program 417 of the secondary site, and determines whether there is an unprocessed journal (step S2305). If there is an unprocessed journal (step S2305; true), the pair cancellation program 417 of the primary site calls the journal transmission program 406 (step S2306) and calls the block release program 409 (step S2307), and the processing is ended.

When the journal transmitted in step S2306 is received (step S2308), the pair cancellation program 417 of the secondary site calls the journal data storage address determination program 403 (step S2309), and stores the journal data in the cache (step S2310). Then, the journal control block storage address determination program 404 is called (step S2311), and the journal control block is stored in the cache (step S2312). Thereafter, the journal restore program 408 is called (step S2313), and the processing returns to step S2303.

If there is no unprocessed journal (step S2305; false), the pair cancellation program 417 of the primary site issues a pair cancellation command (step S2314). The pair cancellation program of the secondary site receives the pair cancellation command from the primary site and deletes the related information (step S2315), and the processing is ended. The re-site pair cancellation program 417 cancels the pair upon receiving the related information deletion at the secondary site and deletes the related information at the primary site (step S2316), and the processing is ended.

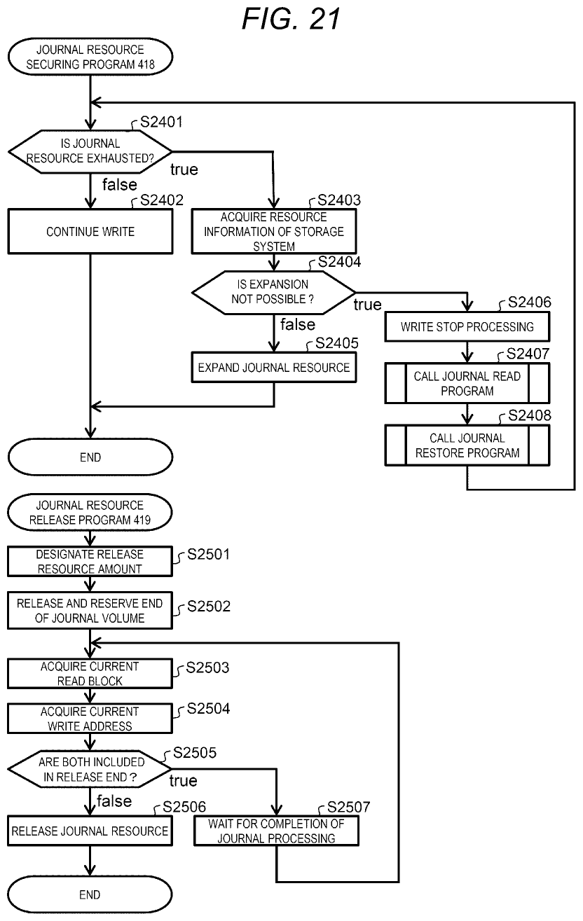

As shown in FIG. 21, the journal resource securing program 418 determines whether journal resource is exhausted (step S2401). If the journal resource is not exhausted (step S2401; false), the journal resource securing program 418 continues write (step S2402), and the processing is ended.

If the journal resource is exhausted (step S2401; true), the journal resource securing program 418 acquires resource information of the storage system (step S2403), and determines whether expansion is not possible (step S2404). If the expansion is possible (step S2404; false), the journal resource securing program 418 expands the journal resource (step S2405), and the processing is ended.

If the expansion is not possible (step S2404; true), the journal resource securing program 418 performs write stop processing (step S2406). Then, the journal read program 405 is called (step S2407), the journal restore program 408 is called (step S2408), and the processing returns to step S2401.

As shown in FIG. 21, the journal resource release program 419 designates a release resource amount (step S2501), and releases and reserves an end of the journal volume (step S2502). Then, the current read block is acquired (step S2503), and the current write address is acquired (step S2504). The journal resource release program 419 determines whether both are included in the release end (step S2505), and if both are included (step S2505; true), waits for completion of journal processing (step S2507), and the processing proceeds to step S2503. On the other hand, if only one is included in the release end, the journal resource is released (step S2506) and the processing is ended.

In the above description, the description is given by illustrating a configuration in which the data processing such as write and the operation of the snapshot that are performed at the primary site are accumulated in the primary site journal together with the time point information, and executed at the secondary site in an order of execution. However, if the operation does not affect the content of the data, the accumulation in the primary site journal is not essential, and it is possible to immediately execute and reflect the operation in the secondary site. For example, in the operation management table 508, if the reproduction method is “request transmission”, the operation can be immediately reflected at the secondary site without affecting the data.

Upon receiving the operation, the operation reflection program 410 determines whether the operation is an operation that cannot be immediately reflected.

As a result of the determination, if the operation is an operation that can be immediately reflected, the operation reflection program 410 transmits the operation to the secondary site, and the processing is ended. On the other hand, if the operation is an operation that cannot be immediately reflected, the operation is added to the journal and the processing is ended.

As described above, the remote copy system according to the present embodiment includes the first storage system 103A that provides the primary site and the second storage system 103B that provides the secondary site. The storage controller 104 of the storage system 103 performs remote copy from the first data volume PVOL of the first storage system 103A to the second data volume SVOL of the second storage system 103B, after the failover is performed from the primary site to the secondary site, accumulates the data and the operation that are processed at the secondary site in the journal volume of the second storage system 103B as the secondary site journal, and restores the first data volume PVOL using the secondary site journal when the primary site is recovered. Therefore, it is possible to quickly and easily switch between the storage systems.

According to the present embodiment, when restoring the first data volume PVOL, the storage controller 104 transmits the secondary site journal to the first storage system 103A, and performs the processing indicated in the secondary site journal in order, so that the first data volume PVOL can be matched with the second data volume SVOL.

According to the present embodiment, the storage controller 104 transmits the data and operation that are processed at the primary site while operating the primary site to the second storage system 103B as the primary site journal, and performs the processing indicated in the primary site journal in order, so that the remote copy can be implemented by matching the second data volume SVOL with the first data volume PVOL.

According to the present embodiment, the storage controller 104 performs, when the data synchronization processing requiring data synchronization is included in the primary site journal, the data synchronization processing in the second storage system 103B in the remote copy, and makes restoring the second data volume SVOL possible based on the data synchronization processing at the time of failover.

This data synchronization processing is, for example, generation of the snapshot. The generation of the snapshot is performed after the data is synchronized. This is because if the snapshot is taken without performing the data synchronization, necessary data may not be included.

In addition, the data synchronization processing includes VOL expansion, clone, VOL reduction, Tier migration, and the like. In a case where the VOL expansion is performed without performing the data synchronization, when there are clones therebetween, clones with different capacities for the primary and secondary are created. When a clone is generated without performing the data synchronization, there may be no necessary data in the clone. When the VOL reduction is performed without performing the data synchronization, data that does not arrive may be written out of a region. In the Tier migration, hint information is transmitted in synchronization with the data. Different data may be moved when the hint information is sent without performing the synchronization.

According to the present embodiment, the storage controller 104 can generate difference information for the processing of the data performed after the failover. In a case of generating the snapshot after the failover, the storage controller 104 can generate the snapshot reflecting the difference information up to that point, and can newly generate the difference information for subsequent data processing.

According to the present embodiment, if the secondary site journal includes generation of a plurality of snapshots in the restoration of the first data volume PVOL, the storage controller 104 can sequentially perform generation of the plurality of snapshots, use corresponding difference information for processing data between the snapshots, and handle the difference information after use as unnecessary information.

According to the present embodiment, the storage system 106 as a monitoring device configured to monitor the operating states of the first storage system 103A and the second storage system 103B is further provided, and the storage controller 104 can automatically execute the failover based on a result of the monitoring.

The disclosure is not limited to the above embodiment, and includes various modifications. For example, the embodiment described above is described in detail for easy understanding of the disclosure, and the disclosure is not necessarily limited to those including all of the configurations described above. The configuration is not limited to being deleted, and may be replaced or added.

The configurations, functions, processing units, processing methods and the like described above may be implemented by hardware by designing a part or all of the configurations, functions, processing units, processing methods and the like with, for example, an integrated circuit. The disclosure can also be implemented by program code of software that implements the functions according to the embodiment. In this case, a storage medium recording the program code is provided to a computer, and a processor provided in the computer reads out the program code stored in the storage medium. In this case, the program code itself read out from the storage medium implements the functions according to the above-mentioned embodiment, and the program code itself and the storage medium storing the program code constitute the disclosure. As a storage medium for supplying such program code, for example, a flexible disk, a CD-ROM, a DVD-ROM, a hard disk, a solid state drive (SSD), an optical disk, a magneto-optical disk, a CD-R, a magnetic tape, a nonvolatile memory card, or a ROM is used.

For example, the program code that implements the function described in the present embodiment can be implemented by a wide range of programs or script languages, such as an assembler, C/C++, perl, Shell, PHP, and Java (registered trademark).

In the embodiment described above, control lines and information lines are considered to be necessary for description, and all control lines and information lines are not necessarily shown in the product. All configurations may be connected to one another.

1. A remote copy system comprising:
a first storage system that provides a primary site; and
a second storage system that provides a secondary site, wherein
a storage controller of the remote copy system
performs remote copy which is to remotely copy data and operation processed at the primary site while operating the primary site from a first data volume of the first storage system to a second data volume of the second storage system,
in the secondary site, reflects data which is transmitted at the remote copy in the second data volume, and perform operation which is processed at the primary site and transmitted at the remote copy,
after a failover is performed from the primary site to the secondary site, accumulates data and operation that are processed at the secondary site in a journal volume of the second storage system as a secondary site journal, and
reflects data of the secondary site journal in the first data volume and restores the first data volume by performing operation of the secondary site journal in the primary site when the primary site is recovered.

2. The remote copy system according to claim 1, wherein
when restoring the first data volume, the storage controller transmits the secondary site journal to the first storage system, and executes processing indicated in the secondary site journal in order so as to match the first data volume with the second data volume.

3. The remote copy system according to claim 1, wherein
the storage controller transmits data and operation that are processed at the primary site while operating the primary site to the second storage system as a primary site journal, and executes processing indicated in the primary site journal in order so as to implement the remote copy by matching the second data volume with the first data volume.

4. The remote copy system according to claim 3, wherein
the storage controller performs a different operation, when data synchronization processing requiring data synchronization is included in the primary site journal, the data synchronization processing by the second storage system in the remote copy, and is configured to restore the second data volume based on the data synchronization processing at a time of the failover.

5. The remote copy system according to claim 4, wherein
the data synchronization processing includes generation of at least one of VOL expansion, a clone, VOL reduction, and Tier migration, and
determines if a failure of the primary site is recovered and performs a failback to recover the primary site and complete a journal operation.

6. The remote copy system according to claim 1, wherein
the storage controller generates difference information for processing of data performed after the failover, in a case of generating a snapshot after the failover, generates the snapshot reflecting difference information up to that point, and newly generates difference information for subsequent data processing.

7. The remote copy system according to claim 6, wherein
if the secondary site journal includes generation of a plurality of snapshots in restoration of the first data volume, the storage controller sequentially performs generation of the plurality of snapshots, uses corresponding difference information for processing data between snapshots, and handles the difference information after use as unnecessary information.

8. The remote copy system according to claim 1, further comprising:
a monitoring device configured to monitor operating states of the first storage system and the second storage system, wherein
the storage controller refers to a Quorum based on a result of the monitoring and automatically executes the failover based on the result of the monitoring.

9. A remote copy management method used by a first storage system that provides a primary site and a second storage system that provides a secondary site, the remote copy management method comprising:
performing remote copy which is to remotely copy data and operation processed at the primary site while operating the primary site from a first data volume of the first storage system to a second data volume of the second storage system;
reflecting data, in the secondary site, which is transmitted at the remote copy in the second data volume, and performing operation which is processed at the primary site and transmitted at the remote copy,
accumulating, after a failover is performed from the primary site to the secondary site, data and operation that are processed at the secondary site in a journal volume of the second storage system as a secondary site journal; and
reflecting data of the secondary site journal in the first data volume and restoring the first data volume using the secondary site journal when the primary site is recovered.
